(19) United States
(12) Patent Application Publication
(10) Pub. No.: US 2016/0054072 A1
(43) Pub. Date: Feb. 25, 2016

(54) A HEAT EXCHANGER WITH A DUAL-FUNCTION DISPENSING HEAD CONNECTION ASSEMBLY

(71) Applicant: Fives Cryo, Golbey (FR)

(72) Inventors: Thierry Mazet, Nancy (FR); Johan Dib, Igney (FR)

(21) Appl. No.: 14/784,942

(22) PCT Filed: Apr. 9, 2014
(86) PCT No.: PCT/EP2014/057134

§ 371 Date: Oct. 15, 2015

(30) Foreign Application Priority Data
Apr. 16, 2013 (FR) 13 53430

(51) Int. Cl. F28D 9/00; B23P 15/26; B23K 1/00; F28F 9/00

(52) U.S. Cl. CPC F28D 9/00; F28F 9/00; B23P 15/26; B23K 1/00

(57) ABSTRACT

A heat exchanger and a method for producing said exchanger, comprising a matrix consisting of a stack of etched plates or of a stack of waves, separating sheets and bars, or a combination of the two types of stack, a fluid dispensing head, and an intermediate assembly for connecting the dispensing head to the matrix, wherein the intermediate assembly is fitted and assembled to the matrix in a single step and also forms a position holder for the etched plates and/or the separating sheets and the bars of the matrix stack.

The invention relates to a brazed-plate heat exchanger.

A brazed-plate heat exchanger may be of the type with engraved/etched plates or with separating plates and fins, or may include a combination of engraved plates and separating plates and fins.

The invention is particularly advantageous for carbon steel, stainless steel or refractory alloy exchangers.

Engraved plate heat exchangers are made up of a stack of metal sheets on which etching has been done beforehand on one face and one of the faces is coated with a brazing coating. This section defines a passage in which the fluids flow.

Separating plate and fin heat exchangers are made up of a stack of a set of corrugated mats, separating metal sheets and bars. The separating metal sheets are coated on each face with a brazing coating. These metal sheets are next stacked, spaced apart by the corrugated mats, and closed over their perimeter by bars with a rectangular section. The space between the separating sheets constitutes a passage in which the fluids flow.

The stack formed by engraved plates or corrugated mats, separating metal sheets and bars is generally delimited by first and second plates with a greater thickness than the engraved plates or the separating plates. The assembly forms a core that is brazed in a single operation in a brazing oven.

Fluid dispensing heads are next added to the core. Depending on its location, a dispensing head supplies the core with a fluid or, conversely, sees to the removal of a fluid from the core. The term “collector” is also used to designate the dispensing heads. Subsequently, the term “dispensing head” will be used indifferently to designate a head supplying or discharging fluid from the core.

For an aluminum exchanger, the assembly of the dispensing heads to the core is done by welding according to computation rules and practices that are well defined and widely validated by many embodiments. In the case of heat exchangers made from steel or a refractory alloy, in particular for an assembly of plates and fins, the operation remains delicate to perform, in particular when the fastening must be done along the wall formed by the closing bars. Thus, following this operation, the appearance of cracks is often observed in the brazed joint or the weld seam. These may then be the source of a leak or increased fragility of the structure of the core, which results from the re-melting of the brazed joint and/or the inability of the core to accommodate the thermomechanical welding stresses.

To eliminate this difficulty, if the design of the heat exchanger cannot be modified, it is known to use an intermediate part on which the dispensing head will be assembled. This intermediate part is brazed on the core after the latter has been previously assembled and machined to receive the intermediate part. Thus, its use makes it possible not to perform direct welding of the head on the brazed joints.

Furthermore, in particular if inner surfaces of the exchanger are coated with a catalyst, it may periodically be necessary to perform a deposition using the dispensing heads, for example to renew that catalyst. Again, the presence of intermediate parts makes it possible to deposit and re-weld the dispensing heads without detriment to the quality of the core.

Document FR 2,950,960 A1 describes a solution for implementing an intermediate part in the form of a frame. This solution is not satisfactory because, in the case where the joint plane between the core and the intermediate part is orthogonal to the stacking of the core, a frame does not make it possible to account for the dimensional variations of the core during brazing, in particular the sagging that results from the fusion and exudation of the brazing. It is therefore necessary for the core to be assembled beforehand in a first brazing step, then to be machined to the shape of the frame, the latter being assembled to the core in a second brazing step.

In light of the nature of the brazing alloys used, in particular those that are nickel-based, the machining of the core may cause deterioration of the brazed joint. Furthermore, the double brazing cycle may alter the metallurgical quality of the joint and the base metal, for example due to enlargement of the austenitic grain or an evolution of the brazing/base metal interface of the first brazing.

The invention makes it possible to offset these drawbacks. One aim of the invention is in particular to provide a brazed-plate heat exchanger with good tightness and mechanical solidity, even in applications requiring frequent removal and re-assembly of the dispensing heads, and which could be made simply and reliably.

This aim is achieved by a heat exchanger comprising:
a brazed core made up of a stack of engraved plates or a stack of fins, separating sheets and bars, or a combination of the two types of stack;
a fluid dispensing head; and
an intermediate assembly for connecting the dispensing head to the core; and characterized in that the intermediate assembly and the core are interlocked in one another by a male-female connection, preferably with an undercut, and brazed to one another.

In preferred embodiments, the heat exchanger according to the invention comprises one, several or all of the following, according to all technically possible combinations:
the intermediate assembly contributes to the positioning of the engraved plates and/or separating sheets and bars during the stacking of the core and maintenance in position during brazing;
the intermediate assembly is in a single piece with the dispensing head;
the dispensing head and the intermediate assembly are delimited by a weakening line;
the intermediate assembly is a separate assembly from the dispensing head, which is fastened, and in particular welded, to the dispensing head;
the intermediate assembly comprises two profiles, for example with an L-shaped cross-section;
the intermediate assembly extends longitudinally in a direction substantially orthogonal to the engraved plates or the separating sheets of the core.

The above aim is also achieved by a method for manufacturing a heat exchanger as described above;
the method being characterized in that, before brazing, the intermediate assembly and
the core are interlocked in one another, then the assembly formed by the core and the intermediate assembly is set by brazing in a single operation.

In preferred embodiments, the manufacturing method according to the invention comprises one, several or all of the following features, according to all technically possible combinations:
a brazing reservoir is positioned along the contact surface between the intermediate assembly and the core before brazing;
said interlocking is done by stacking the engraved plates and/or by stacking the fins, the separating sheets and bars of the core along the intermediate assembly;
said interlocking is done with transverse play between the intermediate assembly and the engraved plates and/or the separating sheets and the bars of the core, the transverse play allowing vertical sagging of the core during brazing;
during brazing, the core is maintained in compression;
a step consisting of attaching, in particular by welding, a fluid dispensing head on the intermediate assembly after brazing.

The invention is also based on the idea of using the intermediate assembly, serving to attach the fluid dispensing head to the core of the heat exchanger, also as positioning and stabilization means for the layers during stacking of the core and its sagging during the brazing. The intermediate assembly then performs a dual function of connecting between the core and a fluid dispensing head and positioning and stabilization of the layers of the core.

Aside from the arrangements described above, the invention consists of a certain number of other arrangements that will be discussed more explicitly regarding example embodiments described in reference to the appended drawings, but is in no way limited thereto. In those drawings:

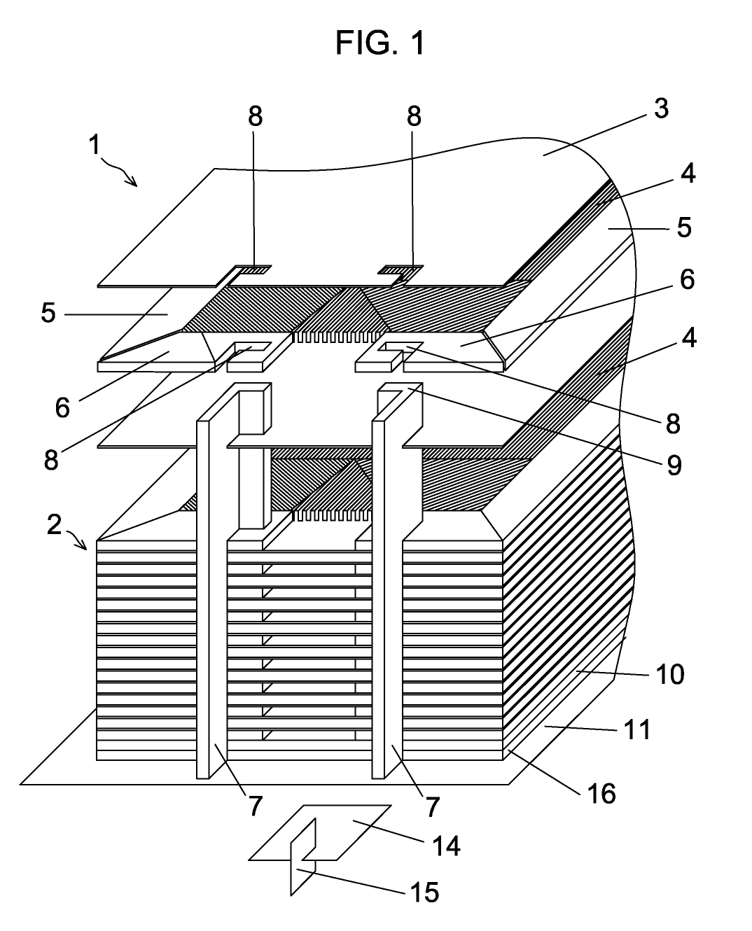

FIG. 1 is a diagrammatic exploded view of a core during stacking with an intermediate assembly including two intermediate parts, according to a first embodiment of the invention,

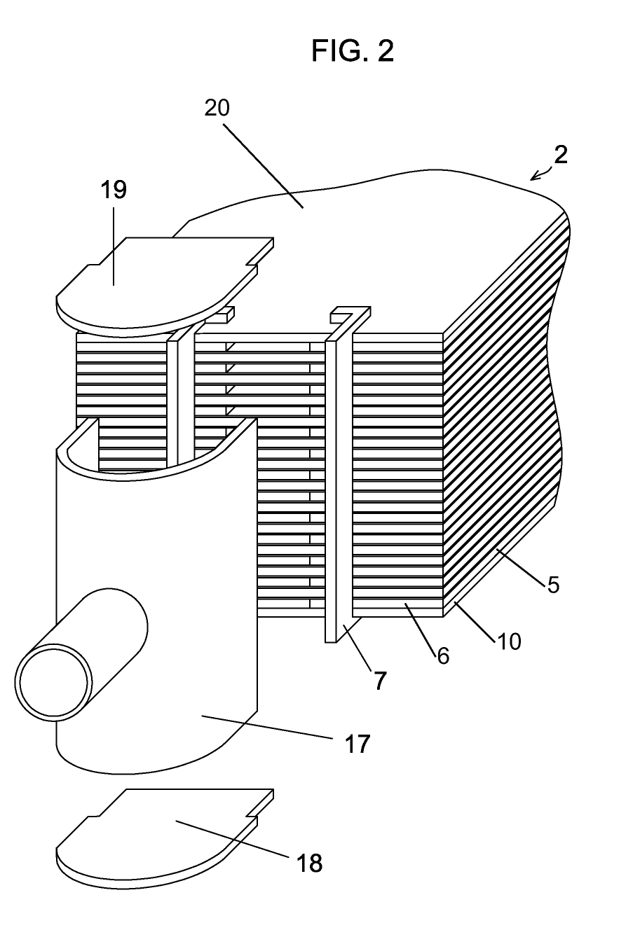

FIG. 2 is a diagrammatic exploded view of a dispensing head added to the core according to the first example embodiment of the invention illustrated in FIG. 1,

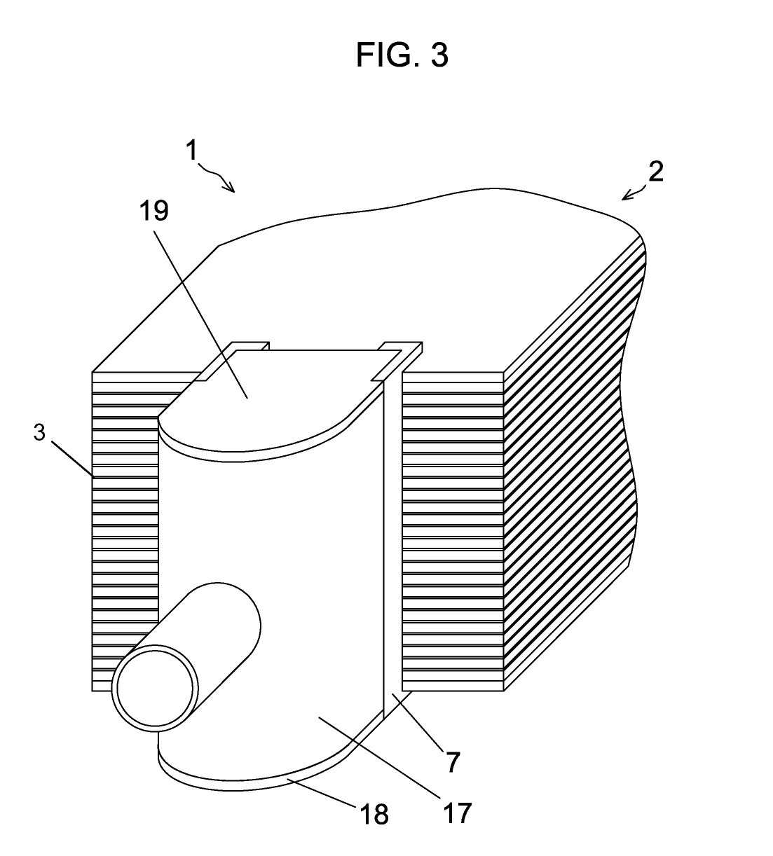

FIG. 3 is a diagrammatic illustration of the finalized exchanger according to the first example embodiment of the invention illustrated in FIGS. 1 and 2, and

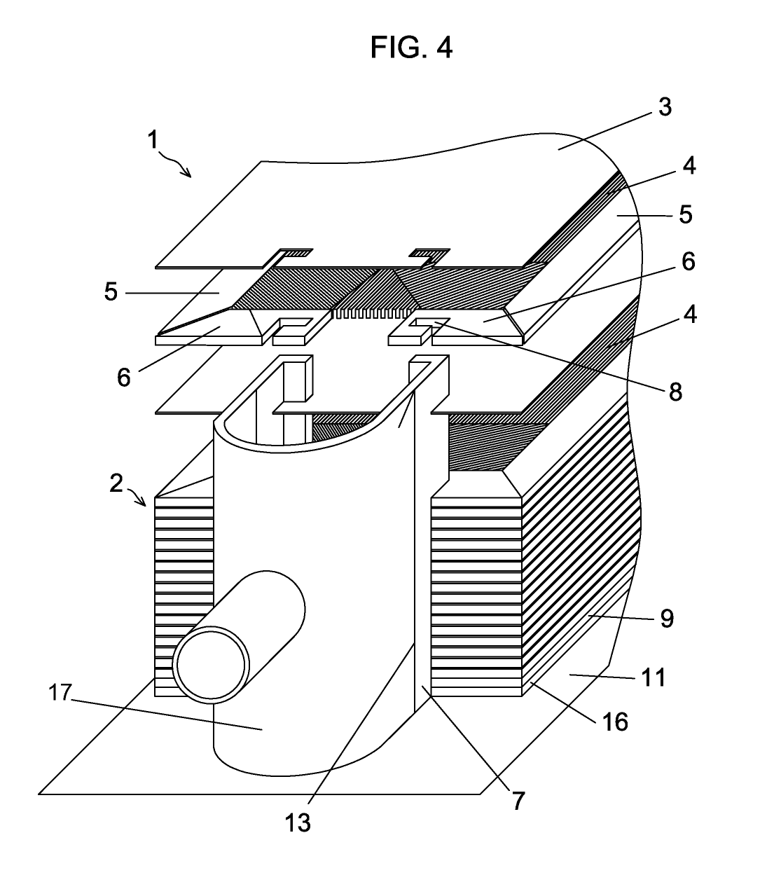

FIG. 4 is a diagrammatic exploded view of a core during stacking with the dispensing head, according to a second example embodiment of the invention.

Hereinafter, in order to simplify the description of the invention, reference will be made to a separating plate and fin exchanger, with the understanding that the invention also applies to an engraved plate exchanger, or an exchanger comprising a combination of separating plates and fins and engraved plates.

FIG. 1 diagrammatically shows a stack of a core 2 during production according to a first example embodiment with an intermediate assembly with two intermediate parts 7 that are L-shaped. In order to simplify the drawings, the description is limited to the placement of a single dispensing head, whereas an exchanger comprises at least two, and often more.

In this example embodiment, the ends of the intermediate parts 7 project on either side of the core 2 in order to receive a plate 19 on each side for closing the dispensing head (cf. FIG. 2). This will be described in more detail below. In order to allow the intermediate parts 7 to project on the side of the core 2 placed on the support surface 11 that serves as lower support for the tooling, a provisional plate 16 is first placed on that support surface 11. The thickness of that plate 16 corresponds to the desired projection of the intermediate parts 7.

Next, a lower end plate 10 of the core 2 is placed on the provisional plate 16, then the intermediate parts 7 are slipped into that lower end plate 10 and placed vertically on the support surface 11. L-shaped openings 8 formed beforehand in the lower end plate 10 hug the shape 9 of the intermediate parts 7. This L shape is illustrative of a simple example embodiment of the invention, but is in no way limiting, other shapes also allowing interlocking between the intermediate parts and the core. After the placement of the lower end plate 10, the interlocking or nesting, with undercut, between the lower end plate 10 and the intermediate parts 7 makes it possible to ensure the maintenance in position of the intermediate parts 7.

Then, a first layer of fins 4 is placed on the lower end plate 10 and surrounded by bars 5, 6. The bars 6 situated on the side of the intermediate parts 7 have L-shaped openings 8 allowing them to slide around the intermediate parts 7. A first intermediate plate 3, also provided with openings 8, is next placed on the fins 4 and the bars 5, 6, by sliding it around the intermediate parts 7. Other layers are then placed until the core 2 is completed with the placement of an upper end plate 20 (cf. FIG. 2).

During the stacking of the core 2, the intermediate parts 7 serve as a squaring system and facilitate and see to the positioning of the successive layers of the core 2. Once the core 2 is complete, the intermediate parts 7 project from the upper side of the core 2 by a length slightly shorter than the thickness of the provisional plate 16 so as to account for the sagging of the core during brazing. Thus, it is possible to eliminate dimensional variations of the core 2 during the brazing cycle. The intermediate parts 7 are only maintained in vertical translation by the support surface 11 until the fusion from the brazing.

As illustrated in FIG. 1, the successive layers of the stack of the core 2 are substantially parallel to the cross-section 14 of the core 2. The intermediate parts 7 extend longitudinally in a direction 15 substantially perpendicular to the cross-section 14 of the core 2.

Once the core 2 is formed, a tooling is placed thereon for maintaining compression, for example simply made up of masses placed above the last plate of the stack. The maintaining tooling ensures the vertical movement of the layers of plates 3, fins 4 and bars 5, 6 of the core 2 that results from the sagging thereof during the fusion from the brazing, while maintaining a sufficient compression force. The intermediate parts 7 placed on the support surface 11 have a stationary position during the brazing. The plates 3 and bars 5, 6 slide along the intermediate parts 7 during the sagging of the core 2. The male-female interlocking between the intermediate parts 7 and the plates 3 and the bars 5, 6 contributes to keeping the core 2 in position during brazing. For an engraved plate exchanger, the invention likewise makes it possible for the engraved plates to slide along the intermediate parts during the fusion from the brazing.

According to this example embodiment, the two intermediate parts 7 are profiles with an

L-shaped cross-section, the bases of the L shapes being turned toward one another. The transverse play between the profile of the profiles 7 and the openings 8 must be sufficient to allow the assembly of the core 2, then the relative vertical movement between the profiles 7 and the plates 3 and bars 5, 6 during brazing. This transverse play is for example comprised between 0.1 and 0.4 mm.

Advantageously, a brazing reservoir, in the form of a groove, is present along the interface between the male part of the profiles 7 and the female parts, i.e., the openings 8 of the plates 3, 10, 20 and the bars 6. The existence of this reservoir ensures the presence of brazing over the entire length of the contact surface between the intermediate parts 7 and the core 2. Furthermore, when the intermediate parts 7 are placed vertically, the composition of the braze is adapted so that the state of the brazing avoids streaming.

According to one alternative embodiment, the successive layers of the core 2 are stacked traditionally, then the intermediate parts 7 are slid into the alignment of the openings 8 of the core 2. However, due to the limited transverse play between the core 2 and the intermediate parts 7 to ensure the quality of the connection during the brazing, it is necessary to have a very precise alignment between the successive layers of the core 2 to be able to slide the intermediate parts 7 therein. To avoid this drawback, and advantageously according to the invention, the intermediate parts 7 serve as guides for stacking of the core 2 as previously described.

FIG. 2 diagrammatically shows the core 2 once the brazing operation has been performed. This figure shows that the intermediate parts 7 project from both sides of the core. A dispensing head 17 with a substantially semi-cylindrical shape is then attached on the core 2 by welding its end edges on those of its parallel branches of the intermediate parts 7, which protrude laterally relative to the core. End plates 18 and 19 are next attached on the dispensing head 17 to obstruct the ends of the dispensing head 17.

FIG. 3 diagrammatically shows the finalized exchanger 1 comprising the core 2, to which the dispensing head 17 with the end plates 18 and 19 has been attached. The latter plates include two cutouts 20 that are inserted closely into the Ls of the parts 7, and press it on the upper and lower faces of the end plates 10 and 20 of the core.

FIG. 4 diagrammatically shows another example embodiment of the invention, in which the dispensing head 17 is extended by the intermediate parts 7. The intermediate parts 7 are thus secured to the dispensing head 17 before the assembly of the core 2. The intermediate parts 7 can have been added to the dispensing head 17, for example by welding, or be an integral part thereof. Thus, the dispensing head 17 can be made from a single piece comprising the shape of the intermediate pieces 7.

The assembly method of the core 2 is similar to that previously described in reference to FIG. 1. The assembly formed by the core 2 and the dispensing head 17 is brazed in a single operation, directly in the brazing oven.

For maintenance operations of the heat exchanger 1 that require removing the dispensing head 17, for example to change catalyst within the heat exchanger 1, the dispensing head 17 will be cut out. This cutout is done at a line 13 corresponding to the weld joint of the dispensing head 17 and the intermediate parts 7 are welded, or for example a slot reducing the thickness of material in that location and thereby facilitating the cutout of the dispensing head 17 and the intermediate parts 7 are in a single piece.

After the cutout and the maintenance operations, the dispensing head 17 can be replaced by welding on the intermediate parts 7, which remain secured to the core 2.

1. A heat exchanger, comprising:
a brazed core made up of a stack of engraved plates or a stack of fins, separating sheets and bars, or a combination of the two types of stack;
a fluid dispensing head; and
an intermediate assembly for connecting the dispensing head to the core, wherein the intermediate assembly and the core are interlocked in one another by a male-female connection, and brazed to one another.

2. The heat exchanger according to claim 1, wherein the intermediate assembly contributes to the positioning of the engraved plates and/or separating sheets and bars during the stacking of the core and maintenance in position during brazing.

3. The heat exchanger according to claim 1, wherein the intermediate assembly is in a single piece with the dispensing head.

4. The heat exchanger according to claim 3, wherein the dispensing head and the intermediate assembly are delimited by a weakening line.

5. The heat exchanger according to claim 1, wherein the intermediate assembly is a separate assembly from the dispensing head, which is fastened, and in particular welded, to the dispensing head.

6. The heat exchanger according to claim 1, wherein the intermediate assembly comprises two profiles.

7. The heat exchanger according to claim 1, wherein the intermediate assembly extends longitudinally in a direction substantially orthogonal to the engraved plates or the separating sheets of the core.

8. A method for manufacturing a heat exchanger according to claim 1, wherein, before brazing, the intermediate assembly and the core are interlocked in one another, then the assembly formed by the core and the intermediate assembly is set by brazing in a single operation.

9. The manufacturing method according to claim 8, wherein a brazing reservoir is positioned along the contact surface between the intermediate assembly and the core before brazing.

10. The manufacturing method according to claim 8, wherein said interlocking is done by stacking the engraved plates and/or by stacking the fins, the separating sheets and bars of the core along the intermediate assembly.

11. The manufacturing method according to claim 8, wherein said interlocking is done with transverse play between the intermediate assembly and the engraved plates and/or the separating sheets and the bars of the core, the transverse play allowing vertical sagging of the core during brazing.

12. The manufacturing method according to claim 8, wherein during brazing, the core is maintained in compression.

13. The manufacturing method according to claim 8, further including a step consisting of assembling a fluid dispensing head to the intermediate assembly after brazing.

14. The heat exchanger according to claim 1, wherein the intermediate assembly and the core are interlocked in one another by a male-female connection with an undercut.

15. The heat exchanger according to claim 6, wherein at least one of the two profiles has an L-shaped cross-section.

16. The manufacturing method according to claim 13, wherein the assembling step is done by welding.
